(19) United States
(12) Patent Application Publication
(10) Pub. No.: US 2020/0228831 A1
(43) Pub. Date: Jul. 16, 2020

(54) INTRA PREDICTION MODE BASED IMAGE PROCESSING METHOD, AND APPARATUS THEREFOR

(71) Applicant: LG ELECTRONICS INC., Seoul (KR)

(72) Inventors: Jin HEO, Seoul (KR); Seunghwan KIM, Seoul (KR)

(21) Appl. No.: 16/633,073

(22) PCT Filed: Jul. 26, 2018
(86) PCT No.: PCT/KR2018/008478

§ 371 Date: Jan. 22, 2020

Related U.S. Application Data
(60) Provisional application No. 62/537,419, filed on Jul. 26, 2017.

(51) Int. Cl. H04N 19/593; H04N 19/176

(52) U.S. Cl. CPC H04N 19/593; H04N 19/176

(57) ABSTRACT

Disclosed herein are an intra prediction mode based image processing method and an apparatus therefor. Specifically, a method for processing an image based on an intra prediction mode may include: deriving an intra prediction mode of a current block; deriving a first reference sample from at least one reference sample of left, top, top left, bottom left, and top right reference samples of the current block based on the intra prediction mode; deriving a second reference sample from at least one reference sample of right, bottom, and bottom right reference samples of the current block based on the intra prediction mode; dividing the current block into a first sub-region and a second sub-region; generating a prediction sample for the first sub-region using the first reference sample; and generating a prediction sample for the second sub-region using the first reference sample and the second reference sample.

### CROSS-REFERENCE TO RELATED APPLICATIONS

This application is the National Stage filing under 35 U.S.C. 371 of International Application No. PCT/KR2018/008478, filed on Jul. 26, 2018, which claims the benefit of U.S. Provisional Applications No. 62/537,419, filed on Jul. 26, 2017, the contents of which are all hereby incorporated by reference herein in their entirety.

### TECHNICAL FIELD

The disclosure relates to a still image or moving image processing method and, more particularly, to a method of encoding/decoding a still image or moving image based on an intra prediction mode and an apparatus supporting the same.

### BACKGROUND ART

A compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

### DISCLOSURE

### Technical Problem

An embodiment of the present disclosure proposes a linear interpolation intra prediction method for generating a prediction sample to which a weight is applied based on a distance between a prediction sample and a reference sample.

Furthermore, an embodiment of the present disclosure proposes a method for more accurately generating a prediction sample by combining conventional general intra prediction and linear interpolation intra prediction.

Furthermore, an embodiment of the present disclosure proposes a method for selectively applying conventional general intra prediction and linear interpolation intra prediction based on a distance between a prediction sample and a reference sample of a reconstructed region.

The technical objects of the present disclosure are not limited to the aforementioned technical objects, and other technical objects, which are not mentioned above, will be apparently appreciated by a person having ordinary skill in the art from the following description.

### Technical Solution

In an aspect of the present disclosure, provided is a method for processing an image based on an intra prediction mode which may include: deriving an intra prediction mode of a current block; deriving a first reference sample from at least one reference sample of left, top, top left, bottom left, and top right reference samples of the current block based on the intra prediction mode; deriving a second reference sample from at least one reference sample of right, bottom, and bottom right reference samples of the current block based on the intra prediction mode; dividing the current block into a first sub-region and a second sub-region; generating a prediction sample for the first sub-region using the first reference sample; and generating a prediction sample for the second sub-region using the first reference sample and the second reference sample.

Preferably, the first sub-region may include one sample line adjacent to a reference sample determined according to a prediction direction of the intra prediction mode among the left, top, top left, bottom left, and right reference samples of the current block.

Preferably, the first sub-region may include a specific number of sample lines adjacent to the reference sample determined according to the prediction direction of the intra prediction mode among the left, top, top left, bottom left, and top right reference samples of the current block.

Preferably, the specific number may be determined based on at least one of a distance between a current sample and the first reference sample in the current block, a size of the current block, or the intra prediction mode.

Preferably, the generating of the prediction sample for the second sub-region may include generating a first prediction sample using the first reference sample and generating a second prediction sample using the second reference sample, and generating a final prediction sample for the second sub-region by performing a weighted-addition of the first prediction sample and the second prediction sample.

Preferably, weights applied to the first prediction sample and the second prediction sample, respectively may be determined based on ratios between the distance between the current sample and the first reference sample and a distance between the current sample and the second reference sample in the current block.

In another aspect of the present disclosure, provided is an apparatus for processing an image based on an intra prediction mode which may include: a prediction mode derivation unit deriving an intra prediction mode of a current block; a first reference sample derivation unit deriving a first reference sample from at least one reference sample of left, top, top left, bottom left, and top right reference samples of the current block based on the intra prediction mode; a second reference sample deriving unit deriving a second reference sample from at least one reference sample of right, bottom, and bottom right reference samples of the current block based on the intra prediction mode; a sub-region division unit dividing the current block into a first sub-region and a second sub-region; and a prediction sample generation unit generating a prediction sample for the first sub-region using the first reference sample and generating a prediction sample for the second sub-region using the first reference sample and the second reference sample.

Preferably, the first sub-region may include one sample line adjacent to a reference sample determined according to a prediction direction of the intra prediction mode among the left, top, top left, bottom left, and right reference samples of the current block.

Preferably, the first sub-region may include a specific number of sample lines adjacent to the reference sample determined according to the prediction direction of the intra prediction mode among the left, top, top left, bottom left, and top right reference samples of the current block.

Preferably, the specific number may be determined based on at least one of a distance between a current sample and the first reference sample in the current block, a size of the current block, or the intra prediction mode.

Preferably, the prediction sample generation unit may generate a first prediction sample using the first reference sample and generate a second prediction sample using the second reference sample, and generates a final prediction sample for the second sub-region by performing a weighted-addition of the first prediction sample and the second prediction sample.

Preferably, weights applied to the first prediction sample and the second prediction sample, respectively may be determined based on ratios between the distance between the current sample and the first reference sample and a distance between the current sample and the second reference sample in the current block.

### Advantageous Effects

According to an embodiment of the present disclosure, a prediction sample is generated using a plurality of reference samples determined according to an intra prediction mode to enhance compression efficiency compared with conventional image compression technology.

Furthermore, according to an embodiment of the present disclosure, a reference sample used for prediction is adaptively determined based on a distance between a prediction sample and a reference sample of a reconstructed region to effectively reflect accuracy of a sample value of the reconstructed region and further increasing accuracy of prediction.

Effects obtainable in the present disclosure are not limited to the aforementioned effects and other unmentioned effects will be clearly understood by those skilled in the art from the following description.

### DESCRIPTION OF DRAWINGS

The accompanying drawings, which are included herein as a part of the description for help understanding the disclosure, provide embodiments of the disclosure, and describe the technical features of the disclosure with the description below.

FIG. 1 is an embodiment to which the disclosure is applied, and shows a schematic block diagram of an encoder in which the encoding of a still image or moving image signal is performed.

FIG. 2 is an embodiment to which the disclosure is applied, and shows a schematic block diagram of a decoder in which the encoding of a still image or moving image signal is performed.

FIG. 3 is a diagram for illustrating the split structure of a coding unit to which the disclosure may be applied.

FIG. 4 is a diagram for illustrating a prediction unit to which the disclosure may be applied.

FIG. 5 is an embodiment to which the disclosure is applied and is a diagram illustrating an intra prediction method.

FIG. 6 illustrates prediction directions according to intra prediction modes.

FIGS. 7 and 8 are diagrams for describing a linear interpolation prediction method as an embodiment to which the present disclosure is applied.

FIG. 9 is a diagram for describing a lower right end reference sample generating method in a linear interpolation prediction method in the related art as an embodiment to which the present disclosure may be applied.

FIG. 10 is a diagram for describing a method for generating right reference samples and lower reference samples as an embodiment to which the present disclosure is applied.

FIGS. 11 and 12 are diagrams for describing a comparison of a conventional intra prediction method and a linear interpolation intra prediction method as an embodiment to which the present disclosure may be applied.

FIG. 13 is a diagram for describing a new intra prediction method according to an embodiment of the present disclosure.

FIG. 14 is a diagram illustrating an inter prediction method according to an embodiment of the present disclosure.

FIG. 15 is a diagram more specifically illustrating an intra prediction unit according to an embodiment of the present disclosure.

FIG. 16 is a structural diagram of a content streaming system as an embodiment to which the present disclosure is applied.

### MODE FOR INVENTION

Hereinafter, preferred embodiments of the disclosure will be described by reference to the accompanying drawings. The description that will be described below with the accompanying drawings is to describe exemplary embodiments of the disclosure, and is not intended to describe the only embodiment in which the disclosure may be implemented. The description below includes particular details in order to provide perfect understanding of the disclosure. However, it is understood that the disclosure may be embodied without the particular details to those skilled in the art.

In some cases, in order to prevent the technical concept of the disclosure from being unclear, structures or devices which are publicly known may be omitted, or may be depicted as a block diagram centering on the core functions of the structures or the devices.

Further, although general terms widely used currently are selected as the terms in the disclosure as much as possible, a term that is arbitrarily selected by the applicant is used in a specific case. Since the meaning of the term will be clearly described in the corresponding part of the description in such a case, it is understood that the disclosure will not be simply interpreted by the terms only used in the description of the disclosure, but the meaning of the terms should be figured out.

Specific terminologies used in the description below may be provided to help the understanding of the disclosure. Furthermore, the specific terminology may be modified into other forms within the scope of the technical concept of the disclosure. For example, a signal, data, a sample, a picture, a frame, a block, etc may be properly replaced and interpreted in each coding process.

Hereinafter, in this disclosure, a “processing unit” means a unit by which an encoding/decoding processing process, such as prediction, transform and/or quantization, is performed. Hereinafter, for convenience of description, a processing unit may also be called a “processing block” or “block.”

A processing unit may be construed as a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as a unit for a luma component or a unit for a chroma component. For example, a processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Furthermore, the disclosure is not limited thereto, and a processing unit may be construed as a meaning including a unit for a luma component and a unit for a chroma component.

Furthermore, a processing unit is not essentially limited to a block of a square, but may have a polygon form having three or more vertexes.

Furthermore, hereinafter, in this disclosure, a pixel or pixel element is collected referred to as a sample. Furthermore, using a sample may mean using a pixel value or a pixel element value.

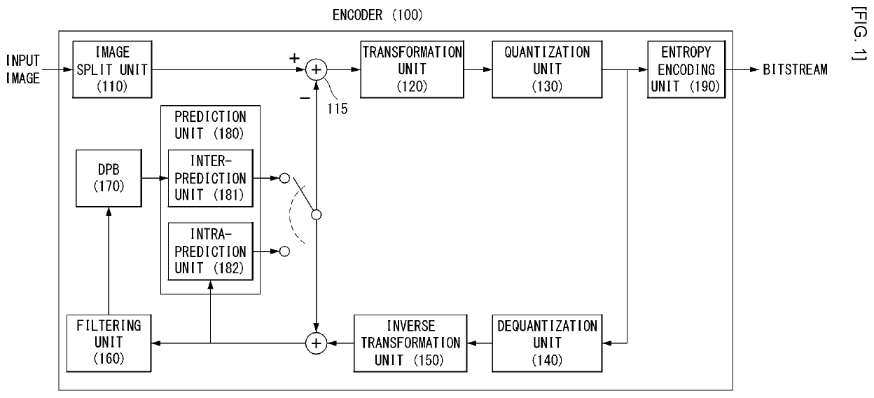

FIG. 1 is an embodiment to which the disclosure is applied, and shows a schematic block diagram of an encoder in which the encoding of a still image or moving image signal is performed.

Referring to FIG. 1, an encoder 100 may include an image split unit 110, a subtraction unit 115, a transformation unit 120, a quantization unit 130, a dequantization unit 140, an inverse transformation unit 150, a filtering unit 160, a decoded picture buffer (DPB) 170, a prediction unit 180 and an entropy encoding unit 190. Furthermore, the prediction unit 180 may include an inter prediction unit 181 and an intra prediction unit 182.

The image split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., inter prediction unit 181 or intra prediction unit 182), from the input video signal. The generated residual signal (or residual block) is transmitted to the transformation unit 120.

The transformation unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transformation unit 120 may generate the transform coefficients by performing transform using a determined transform scheme depending on a prediction mode applied to the residual block and the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal that is outputted from the quantization unit 130 may be used for generating a prediction signal. For example, by applying dequantization and inverse transformation to the quantized signal through the dequantization unit 140 and the inverse transformation unit 150, the residual signal may be reconstructed. By adding the reconstructed residual signal to the prediction signal that is outputted from the inter prediction unit 181 or the intra prediction unit 182, a reconstructed signal may be generated.

Meanwhile, during such a compression process, adjacent blocks are quantized by different quantization parameters from each other, and accordingly, an artifact in which block boundaries are shown may occur. Such a phenomenon is referred to blocking artifact, which is one of the important factors for evaluating image quality. In order to decrease such an artifact, a filtering process may be performed. Through such a filtering process, the blocking artifact is removed and the error for the current picture is decreased at the same time, thereby the image quality being improved.

The filtering unit 160 applies filtering to the reconstructed signal, and outputs it through a play-back device or transmits it to the decoded picture buffer 170. The filtered signal transmitted to the decoded picture buffer 170 may be used as a reference picture in the inter prediction unit 181. As such, by using the filtered picture as a reference picture in an inter picture prediction mode, the encoding rate as well as the image quality may be improved.

The decoded picture buffer 170 may store the filtered picture in order to use it as a reference picture in the inter prediction unit 181.

The inter prediction unit 181 performs a temporal prediction and/or a spatial prediction by referencing the reconstructed picture in order to remove a temporal redundancy and/or a spatial redundancy. In this case, since the reference picture used for performing a prediction is a transformed signal that goes through the quantization or the dequantization by a unit of block when being encoded/decoded previously, there may exist blocking artifact or ringing artifact.

Accordingly, in order to solve the performance degradation owing to the discontinuity of such a signal or the quantization, by applying a low pass filter to the inter prediction unit 181, the signals between pixels may be interpolated by a unit of sub-pixel. Herein, the sub-pixel means a virtual pixel that is generated by applying an interpolation filter, and an integer pixel means an actual pixel that is existed in the reconstructed picture. As a method of interpolation, a linear interpolation, a bi-linear interpolation, a wiener filter, and the like may be applied.

The interpolation filter may be applied to the reconstructed picture, and may improve the accuracy of prediction. For example, the inter prediction unit 181 may perform prediction by generating an interpolation pixel by applying the interpolation filter to the integer pixel, and by using the interpolated block that includes interpolated pixels as a prediction block.

The intra prediction unit 182 predicts the current block by referring to the samples adjacent the block that is to be encoded currently. The intra prediction unit 182 may perform the following procedure in order to perform the intra prediction. First, the intra prediction unit 182 may prepare a reference sample that is required for generating a prediction signal. Furthermore, the intra prediction unit 182 may generate a prediction signal by using the reference sample prepared. After, the intra prediction unit 182 may encode the prediction mode. In this case, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra prediction.

In particular, the intra prediction unit 182 according to the disclosure may perform intra prediction on a current block by linearly interpolating prediction sample values generated based on the intra prediction mode of the current block. The intra prediction unit 182 is described in more detail later.

The prediction signal (or prediction block) generated through the inter prediction unit 181 or the intra prediction unit 182 may be used to generate a reconstructed signal (or reconstructed block) or may be used to generate a residual signal (or residual block).

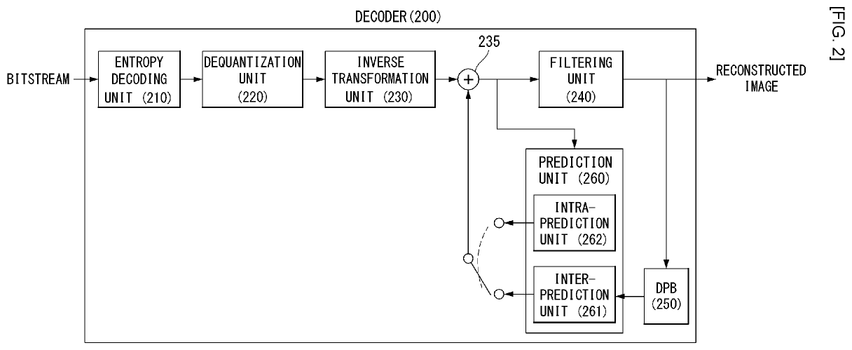

FIG. 2 is an embodiment to which the disclosure is applied, and shows a schematic block diagram of a decoder in which the encoding of a still image or moving image signal is performed.

Referring to FIG. 2, a decoder 200 may include an entropy decoding unit 210, a dequantization unit 220, an inverse transformation unit 230, an addition unit 235, a filtering unit 240, a decoded picture buffer (DPB) 250 and a prediction unit 260. Furthermore, the prediction unit 260 may include an inter prediction unit 261 and an intra prediction unit 262.

Furthermore, the reconstructed video signal outputted through the decoder 200 may be played through a play-back device.

The decoder 200 receives the signal (i.e., bit stream) outputted from the encoder 100 shown in FIG. 1, and the entropy decoding unit 210 performs an entropy decoding operation of the received signal.

The dequantization unit 220 acquires a transform coefficient from the entropy-decoded signal using quantization step size information.

The inverse transformation unit 230 obtains a residual signal (or residual block) by inversely transforming transform coefficients using an inverse transform scheme.

The adder 235 adds the obtained residual signal (or residual block) to the prediction signal (or prediction block) output by the prediction unit 260 (i.e., inter prediction unit 261 or intra prediction unit 262), thereby generating a reconstructed signal (or reconstructed block).

The filtering unit 240 applies filtering to the reconstructed signal (or reconstructed block) and outputs it to a playback device or transmits it to the decoding picture buffer 250. The filtered signal transmitted to the decoding picture buffer 250 may be used as a reference picture in the inter prediction unit 261.

In this disclosure, the embodiments described in the filtering unit 160, the inter prediction unit 181 and the intra prediction unit 182 of the encoder 100 may also be applied to the filtering unit 240, the inter prediction unit 261 and the intra prediction unit 262 of the decoder, respectively, in the same way.

In particular, the intra prediction unit 262 according to the disclosure may perform intra prediction on a current block by linearly interpolating prediction sample values generated based on an intra prediction mode of the current block. The intra prediction unit 262 is described in detail later.

In general, the block-based image compression method is used in a technique (e.g., HEVC) for compressing a still image or a moving image. A block-based image compression method is a method of processing an image by splitting the video into specific block units, and may decrease the capacity of memory and a computational load.

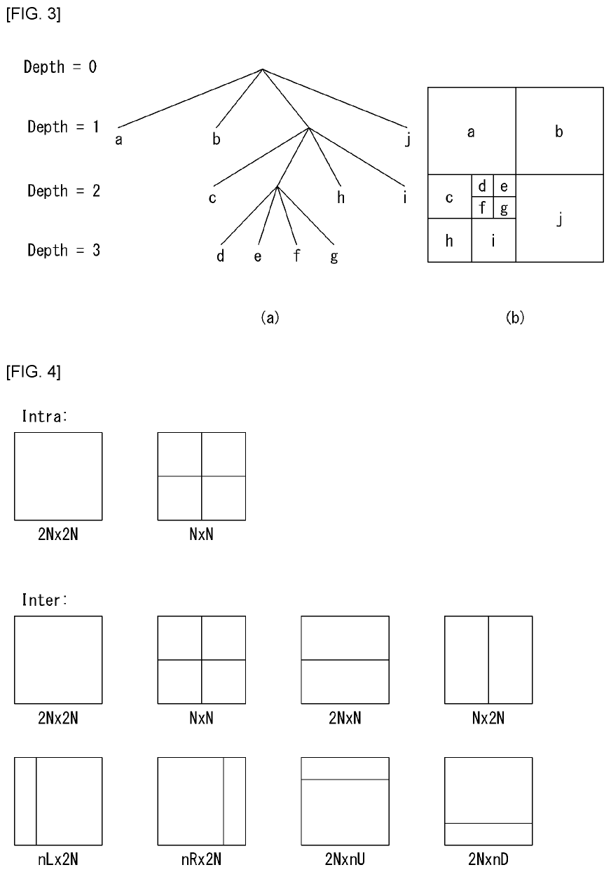

FIG. 3 is a diagram for illustrating the split structure of a coding unit that may be applied to the disclosure.

The encoder splits a single image (or picture) in a coding tree unit (CTU) of a rectangle form, and sequentially encodes a CTU one by one according to raster scan order.

In HEVC, the size of a CTU may be determined to be one of 64×64, 32×32 and 16×16. The encoder may select and use the size of CTU according to the resolution of an input video or the characteristics of an input video. A CTU includes a coding tree block (CTB) for a luma component and a CTB for two chroma components corresponding to the luma component.

One CTU may be split in a quad-tree structure. That is, one CTU may be split into four units, each having a half horizontal size and half vertical size while having a square form, thereby being capable of generating a coding unit (CU). The split of the quad-tree structure may be recursively performed. That is, a CU is hierarchically from one CTU in a quad-tree structure.

A CU means a basic unit for a processing process of an input video, for example, coding in which intra/inter prediction is performed. A CU includes a coding block (CB) for a luma component and a CB for two chroma components corresponding to the luma component. In HEVC, the size of a CU may be determined to be one of 64×64, 32×32, 16×16 and 8×8.

Referring to FIG. 3, a root node of a quad-tree is related to a CTU. The quad-tree is split until a leaf node is reached, and the leaf node corresponds to a CU.

This is described in more detail. A CTU corresponds to a root node and has the deepest depth (i.e., depth=0) value. A CTU may not be split depending on the characteristics of an input video. In this case, the CTU corresponds to a CU.

A CTU may be split in a quad-tree form. As a result, lower nodes of a depth 1 (depth=1) are generated. Furthermore, a node (i.e., a leaf node) no longer split from the lower node having the depth of 1 corresponds to a CU. For example, in FIG. 3(b), a CU(a), CU(b) and CU(j) corresponding to nodes a, b and j have been once split from a CTU, and have a depth of 1.

At least one of the nodes having the depth of 1 may be split in a quad-tree form again. As a result, lower nodes of a depth 2 (i.e., depth=2) are generated. Furthermore, a node (i.e., leaf node) no longer split from the lower node having the depth of 2 corresponds to a CU. For example, in FIG. 3(b), a CU(c), CU(h) and CU(i) corresponding to nodes c, h and i have been twice split from the CTU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from the lower node having the depth of 3 corresponds to a CU. For example, in FIG. 3(b), a CU(d), CU(e), CU(f) and CU(g) corresponding to nodes d, e, f and g have been split from the CTU three times, and have a depth of 3.

In the encoder, a maximum size or minimum size of a CU may be determined according to the characteristics of a video image (e.g., resolution) or by considering encoding rate. Furthermore, information about the size or information capable of deriving the size may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents the split count and/or degree of a CU, the depth information may include information about the size of a CU.

Since the LCU is split in a quad-tree form, the size of the SCU may be obtained using the size of the LCU and maximum depth information. Alternatively, the size of the LCU may be obtained using the size of the SCU and maximum depth information of a tree.

For a single CU, information (e.g., a split CU flag (split_cu_flag)) indicating whether the corresponding CU is split may be forwarded to the decoder. The split information is included in all of CUs except the SCU. For example, when the value of the flag indicating whether to split is ‘1’, the corresponding CU is further split into four CUs, and when the value of the flag that represents whether to split is ‘0’, the corresponding CU is not split any more, and the processing process for the corresponding CU may be performed.

As described above, the CU is a basic unit of the coding in which the intra prediction or the inter prediction is performed. The HEVC splits the CU in a prediction unit (PU) for coding an input video more effectively.

The PU is a basic unit for generating a prediction block, and even in a single CU, the prediction block may be generated in different way by a unit of a PU. However, the intra prediction and the inter prediction are not used together for the PUs that belong to a single CU, and the PUs that belong to a single CU are coded by the same prediction method (i.e., intra prediction or the inter prediction).

The PU is not split in the Quad-tree structure, but is split once in a single CU in a predetermined form. This will be described by reference to the drawing below.

FIG. 4 is a diagram for illustrating a prediction unit that may be applied to the disclosure.

A PU is differently split depending on whether the intra prediction mode is used or the inter prediction mode is used as the coding mode of the CU to which the PU belongs.

FIG. 4(a) illustrates a PU of the case where the intra prediction mode is used, and FIG. 4(b) illustrates a PU of the case where the inter prediction mode is used.

Referring to FIG. 4(a), assuming the case where the size of a single CU is 2N×2N (N=4, 8, 16 and 32), a single CU may be split into two types (i.e., 2N×2N or N×N).

In this case, in the case where a single CU is split into the PU of 2N×2N form, it means that only one PU is existed in a single CU.

In contrast, in the case where a single CU is split into the PU of N×N form, a single CU is split into four PUs, and different prediction blocks are generated for each PU unit. However, such a PU split may be performed only in the case where the size of a CB for the luma component of a CU is a minimum size (i.e., if a CU is the SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N>nU and 2N×nD)

As in intra prediction, the PU split of N×N form may be performed only in the case where the size of a CB for the luma component of a CU is a minimum size (i.e., if a CU is the SCU).

Inter-prediction supports the PU split of a 2N×N form in the horizontal direction and an N×2N form in the vertical direction.

In addition, the inter prediction supports the PU split in the form of nL×2N, nR×2N, 2N×nU and 2N×nD, which is asymmetric motion split (AMP). In this case, ‘n’ means ¼ value of 2N. However, the AMP may not be used in the case where a CU to which a PU belongs is a CU of minimum size.

In order to efficiently encode an input video in a single CTU, the optimal split structure of a coding unit (CU), prediction unit (PU) and transform unit (TU) may be determined based on a minimum rate-distortion value through the processing process as follows. For example, as for the optimal CU split process in a 64×64 CTU, the rate-distortion cost may be calculated through the split process from a CU of a 64×64 size to a CU of an 8×8 size. A detailed process is as follows.

1) The optimal split structure of a PU and TU that generates a minimum rate distortion value is determined by performing inter/intra prediction, transformation/quantization, dequantization/inverse transformation and entropy encoding on a CU of a 64×64 size.

2) The optimal split structure of a PU and TU is determined by splitting a 64×64 CU into four CUs of a 32×32 size and generating a minimum rate distortion value for each 32×32 CU.

3) The optimal split structure of a PU and TU is determined by further splitting a 32×32 CU into four CUs of a 16×16 size and generating a minimum rate distortion value for each 16×16 CU.

4) The optimal split structure of a PU and TU is determined by further splitting a 16×16 CU into four CUs of an 8×8 size and generating a minimum rate distortion value for each 8×8 CU.

5) The optimal split structure of a CU in a 16×16 block is determined by comparing the rate-distortion value of the 16×16 CU obtained in the process of 3) with the addition of the rate-distortion value of the four 8×8 CUs obtained in the process of 4). This process is also performed on the remaining three 16×16 CUs in the same manner.

6) The optimal split structure of a CU in a 32×32 block is determined by comparing the rate-distortion value of the 32×32 CU obtained in the process of 2) with the addition of the rate-distortion value of the four 16×16 CUs obtained in the process of 5). This process is also performed on the remaining three 32×32 CUs in the same manner.

7) Lastly, the optimal split structure of a CU in a 64×64 block is determined by comparing the rate-distortion value of the 64×64 CU obtained in the process of 1) with the addition of the rate-distortion value of the four 32×32 CUs obtained in the process of 6).

In an intra prediction mode, a prediction mode is selected in a PU unit, and prediction and reconstruction are performed on the selected prediction mode in an actual TU unit.

A TU means a basic unit by which actual prediction and reconstruction are performed. A TU includes a transform block (TB) for a luma component and two chroma components corresponding to the luma component.

In the example of FIG. 3, as if one CTU is split in a quad-tree structure to generate a CU, a TU is hierarchically split from one CU to be coded in a quad-tree structure.

A TU is split in the quad-tree structure, and a TU split from a CU may be split into smaller lower TUs. In HEVC, the size of a TU may be determined to be any one of 32×32, 16×16, 8×8 and 4×4.

Referring back to FIG. 3, it is assumed that the root node of the quad-tree is related to a CU. The quad-tree is split until a leaf node is reached, and the leaf node corresponds to a TU.

This is described in more detail. A CU corresponds to a root node and has the deepest depth (i.e., depth=0) value. A CU may not be split depending on the characteristics of an input video. In this case, the CU corresponds to a TU.

A CU may be split in a quad-tree form. As a result, lower nodes, that is, a depth 1 (depth=1), are generated. Furthermore, a node (i.e., leaf node) no longer split from the lower node having the depth of 1 corresponds to a TU. For example, in FIG. 3(b), a TU(a), TU(b) and TUU) corresponding to the nodes a, b and j have been once split from a CU, and have a depth of 1.

At least one of the nodes having the depth of 1 may be split again in a quad-tree form. As a result, lower nodes, that is, a depth 2 (i.e., depth=2), are generated. Furthermore, a node (i.e., leaf node) no longer split from the lower node having the depth of 2 corresponds to a TU. For example, in FIG. 3(b), a TU(c), TU(h) and TU(i) corresponding to the nodes c, h and i have been split twice from the CU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from a lower node having the depth of 3 corresponds to a CU. For example, in FIG. 3(b), a TU(d), TU(e), TU(f), TU(g) corresponding to the nodes d, e, f and g have been split from the CU three times, and have the depth of 3.

A TU having a tree structure may be hierarchically split based on predetermined highest depth information (or highest level information). Furthermore, each split TU may have depth information. The depth information may also include information about the size of the TU because it indicates the number of times and/or degree that the TU has been split.

With respect to one TU, information (e.g., a split TU flag (split_transform_flag)) indicating whether a corresponding TU has been split may be transferred to the decoder. The split information is included in all TUs other than a TU of the least size. For example, if the value of the flag indicating whether a TU has been split is ‘1’, the corresponding TU is split into four TUs. If the value of the flag is ‘0’, the corresponding TU is no longer split.

Prediction

In order to reconstruct a current processing unit on which decoding is performed, the decoded part of a current picture including the current processing unit or other pictures may be used.

A picture (slice) using only a current picture for reconstruction, that is, performing only intra prediction, may be referred to as an intra picture or I picture (slice). A picture (slice) using the greatest one motion vector and reference index in order to predict each unit may be referred to as a predictive picture or P picture (slice). A picture (slice) using a maximum of two motion vectors and reference indices in order to predict each unit may be referred to as a bi-predictive picture or B picture (slice).

Intra-prediction means a prediction method of deriving a current processing block from a data element (e.g., sample value, etc.) of the same decoded picture (or slice). That is, intra prediction means a method of predicting a pixel value of the current processing block with reference to reconstructed regions within a current picture.

Inter-prediction means a prediction method of deriving a current processing block based on a data element (e.g., sample value or motion vector) of a picture other than a current picture. That is, inter prediction means a method of predicting the pixel value of the current processing block with reference to reconstructed regions within another reconstructed picture other than a current picture.

Hereinafter, intra prediction is described in more detail.

Intra-Prediction

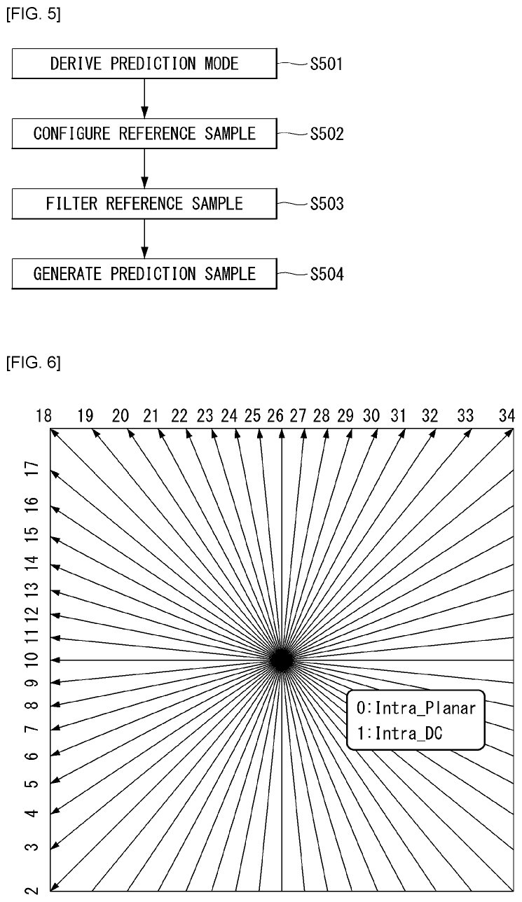

FIG. 5 is an embodiment to which the disclosure is applied and is a diagram illustrating an intra prediction method.

Referring to FIG. 5, the decoder derives an intra prediction mode of a current processing block (S501).

In intra prediction, there may be a prediction direction for the location of a reference sample used for prediction depending on a prediction mode.

An intra prediction mode having a prediction direction is referred to as intra angular prediction mode “Intra_Angular prediction mode.” In contrast, an intra prediction mode not having a prediction direction includes an intra planar (INTRA_PLANAR) prediction mode and an intra DC (INTRA_DC) prediction mode.

Table 1 illustrates intra prediction modes and associated names, and FIG. 6 illustrates prediction directions according to intra prediction modes.

TABLE 1

| Intra | |
|---|---|
| prediction mode | Associated names |
| 0 | INTRA_PLANAR |
| 1 | INTRA_DC |
| 2 . . . 34 | INTRA_ANGULAR2 . . . INTRA_ANGULAR34 |

In intra prediction, prediction may be on a current processing block based on a derived prediction mode. A reference sample used for prediction and a detailed prediction method are different depending on a prediction mode. Accordingly, if a current block is encoded in an intra prediction mode, the decoder derives the prediction mode of a current block in order to perform prediction.

The decoder checks whether neighboring samples of the current processing block may be used for prediction and configures reference samples to be used for prediction (S502).

In intra prediction, neighboring samples of a current processing block mean a sample neighboring the left boundary of the current processing block of an nS×nS size, a total of 2×nS samples neighboring the left bottom of the current processing block, a sample neighboring the top boundary of the current processing block, a total of 2×nS samples neighboring the top right of the current processing block, and one sample neighboring the top left of the current processing block.

However, some of the neighboring samples of the current processing block have not yet been decoded or may not be available. In this case, the decoder may configure reference samples to be used for prediction by substituting unavailable samples with available samples.

The decoder may perform the filtering of the reference samples based on the intra prediction mode (S503).

Whether the filtering of the reference samples will be performed may be determined based on the size of the current processing block. Furthermore, a method of filtering the reference samples may be determined by a filtering flag transferred by the encoder.

The decoder generates a prediction block for the current processing block based on the intra prediction mode and the reference samples (S504). That is, the decoder generates the prediction block for the current processing block (i.e., generates a prediction sample) based on the intra prediction mode derived in the intra prediction mode derivation step S501 and the reference samples obtained through the reference sample configuration step S502 and the reference sample filtering step S503.

If the current processing block has been encoded in the INTRA_DC mode, in order to minimize the discontinuity of the boundary between processing blocks, at step S504, the left boundary sample of the prediction block (i.e., a sample within the prediction block neighboring the left boundary) and the top boundary sample (i.e., a sample within the prediction block neighboring the top boundary) may be filter.

Furthermore, at step S504, in the vertical mode and horizontal mode of the intra angular prediction modes, as in the INTRA_DC mode, filtering may be applied to the left boundary sample or the top boundary sample.

This is described in more detail. If the current processing block has been encoded in the vertical mode or the horizontal mode, the value of a prediction sample may be derived based on a reference sample located in a prediction direction. In this case, a boundary sample that belongs to the left boundary sample or top boundary sample of the prediction block and that is not located in the prediction direction may neighbor a reference sample not used for prediction. That is, the distance from the reference sample not used for prediction may be much closer than the distance from the reference sample used for prediction.

Accordingly, the decoder may adaptively apply filtering on left boundary samples or top boundary samples depending on whether an intra prediction direction is a vertical direction or a horizontal direction. That is, the decoder may apply filtering on the left boundary samples if the intra prediction direction is the vertical direction, and may apply filtering on the top boundary samples if the intra prediction direction is the horizontal direction.

As described above, in HEVC, 33 directivity prediction methods, two non-directivity prediction methods, and a total of 35 prediction methods are used through intra prediction and a prediction sample is generated by using a neighborhood reference sample (when it is assumed that the neighborhood reference sample is encoded/decoded, an upper reference sample or a left reference sample). In addition, the prediction sample is copied which is generated according to the directivity of the intra prediction mode.

Since a prediction sample value is just copied according to a prediction direction, there is a problem occurs in that accuracy of prediction deteriorates as a distance from the reference sample increases. That is, when distances between the reference samples and the prediction sample used for prediction decrease, the prediction accuracy is high, but when the distances between the reference samples and the prediction sample used for prediction increase, the prediction accuracy is low.

In order to reduce prediction errors, the present disclosure proposes a linear interpolation intra prediction method for generating a prediction sample to which a weight is applied based on a distance between a prediction sample and a reference sample. In particular, the present disclosure proposes a method for more accurately generating a lower right end reference sample as compared with the right lower end reference sample generating method in the linear interpolation prediction method which is recently discussed. First, the linear interpolation prediction method will be described with reference to the following drawings.

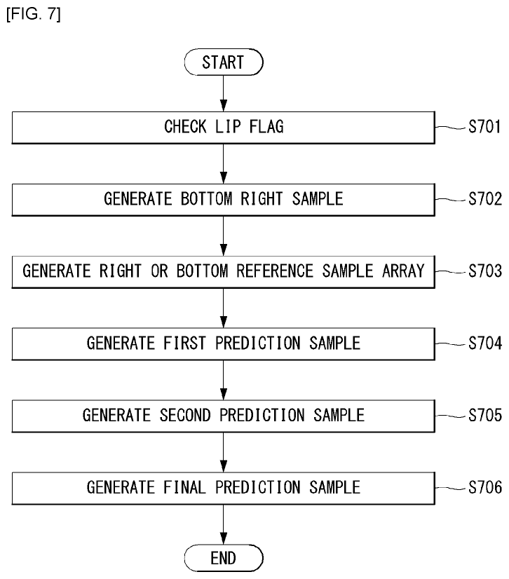

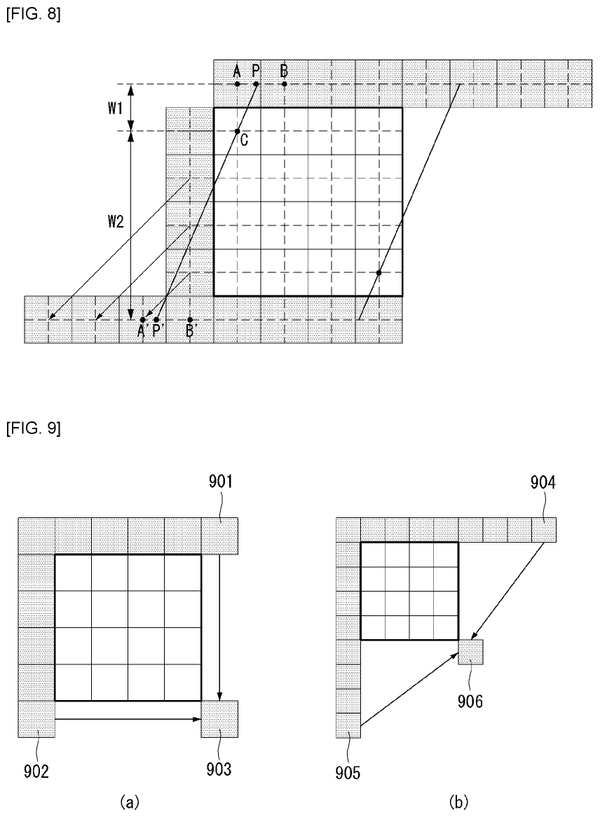

FIGS. 7 and 8 are diagrams for describing a linear interpolation prediction method as an embodiment to which the present disclosure is applied.

Referring to FIG. 7, the decoder is mainly described for convenience of description, but the linear interpolation prediction method proposed in the present disclosure may be equally performed even in the encoder.

The decoder parses (or confirms) an LIP flag indicating whether linear intra prediction (LIP) (or linear interpolation intra prediction) is applied to a current block from a bitstream received from the encoder (S701).

In an embodiment, the decoder may derive an intra prediction mode of the current block before step S701 and derive the intra prediction mode of the current block after step S701. In other words, before or after step S701, a step of deriving the intra prediction mode may be added. In addition, the step of deriving the intra prediction mode may include parsing an MPM flag indicating whether a most probable mode (MPM) is applied to the current block and parsing an index indicating a prediction mode applied to the intra prediction of the current block in an MPM candidate or residual prediction mode candidate according to whether the MPM is applied.

The decoder generates a lower right reference end reference sample adjacent to a lower right side of the current block (S702). The decoder may generate the lower right end reference sample by using various methods. The detailed description thereof will be made later.

The decoder generates a right reference sample array or a lower reference sample array by using a reconstructed reference sample around the current block and the lower right end reference sample generated in step S702 (S703). In the present disclosure, the right reference sample array may be collectively referred to as the right reference sample, a right end reference sample, a right end reference sample array, etc., and a lower reference sample array may be collectively referred to as a lower reference sample, a lower end reference sample, a lower end reference sample array, etc. The detailed description thereof will be made later.

The decoder generates a first prediction sample and a second prediction sample based on the prediction direction of the intra prediction mode of the current block (S704 and S705). Here, the first prediction sample (may be referred to as a first reference sample) and the second prediction sample (may be referred to as a second reference sample) represent reference samples positioned at opposite sides of the current block to each other based on the prediction direction or prediction samples generated using the reference samples positioned at opposite sides of the current block to each other. The first prediction sample represents the prediction sample generated using the first reference sample determined according to the intra prediction mode of the current block among the reference samples (left, top left, and top reference samples) of the reconstructed region as described in FIGS. 5 and 6 above and the second prediction sample represents the prediction sample generated using the second reference sample determined according to the intra prediction mode of the current block in a right reference sample array or a lower reference sample array in step S703.

The decoder interpolates (or linearly interpolates) the first prediction sample and the second prediction sample generated in step S704 and S705 to generate a final prediction sample (S706). In other words, the decoder weight-adds the first prediction sample and the second prediction sample based on the distances between the current sample and the prediction samples (or reference sample) to generate the final prediction sample.

Referring to FIG. 8, the decoder is mainly described for convenience of description, but the linear interpolation prediction method proposed in the present disclosure may be equally performed even in the encoder.

The decoder may generate a first prediction sample P based on the intra prediction mode. Specifically, the decoder may derive the first prediction sample by interpolating (or linearly interpolating) reference sample A and reference sample B determined according to the prediction direction among the upper reference samples. Meanwhile, unlike in FIG. 8, when the reference sample determined according to the prediction direction is positioned at the integer pixel location, the inter-reference sample interpolation may not be performed.

Further, the decoder may generate a second prediction sample P′ based on the intra prediction mode. Specifically, the decoder determines reference sample A′ and reference sample B′ according to the prediction direction of the intra prediction mode of the current block among the lower reference samples and linearly interpolates reference sample A′ and reference sample B′ to derive the second prediction sample. Meanwhile, unlike in FIG. 8, when the reference sample determined according to the prediction direction is positioned at the integer pixel location, the inter-reference sample interpolation may not be performed.

In addition, the decoder determines weights applied the first and second prediction samples, respectively based on the distance between the current sample and the prediction sample (or reference sample) and performs a weighted-addition of the first and second prediction samples using the determined weights to generate the final prediction sample.

The weight determining method (w1 and w2) illustrated in FIG. 8 is one example and the decoder may use a vertical distance between the current sample and the prediction sample (or reference sample) and use an actual distance between the current sample and the prediction sample (or reference sample) as illustrated in FIG. 8. If the actual distance is used, the distance may be calculated and the weight may be determined (or derived) based on an actual location of the second reference sample used for generating the second prediction sample.

FIG. 9 is a diagram for describing a lower right end reference sample generating method in a linear interpolation prediction method in the related art as an embodiment to which the present disclosure may be applied.

Referring to FIG. 9, the encoder/decoder may generate a lower right end reference sample 903 adjacent to a lower right side of the current block by using an upper right end reference sample 901 adjacent an upper right side of the current block and a lower left end reference sample 902 adjacent to a lower left side of the current block.

Referring to FIG. 9(b), the encoder/decoder may generate a lower right end reference sample 906 by using a sample (hereinafter, referred to as an uppermost right end sample) (e.g., a sample apart from the upper left end reference sample of the current block by a distance which is two times larger than a width of the current block in a horizontal direction, i.e., [2*n−1, −1] sample in an n×n block) 904 positioned at a rightmost side among the reference samples neighboring to the upper right side of the current block and a sample (hereinafter, referred to as a lowermost left sample) (e.g., a sample apart from the upper left end reference sample of the current block by a distance which is two times larger than a height of the current block in a vertical direction, i.e., [−1, 2*n−1] sample in the n×n block) 905.

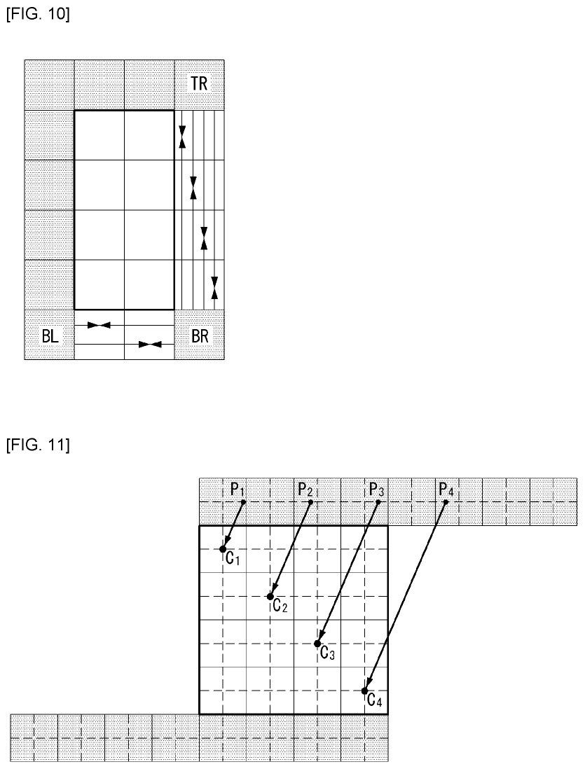

FIG. 10 is a diagram for describing a method for generating right reference samples and lower reference samples as an embodiment to which the present disclosure is applied.

Referring to FIG. 10, the method is described by assuming a case where the size of the current block is 2×4. The encoder/decoder may generate the right reference sample and/or the lower reference sample by using the lower right end reference sample BR adjacent to the lower right side of the current block and the reconstructed reference sample around the current block.

Specifically, the encoder/decoder may generate the lower reference sample by linearly interpolating the bottom right (BR) reference sample and a reference sample (bottom left (BL)) adjacent to the lower left side of the current block. In other words, the encoder/decoder may generate the lower reference samples by performing weighted sum in units of pixel according to a distance ratio for each of the bottom right reference sample (BL) and the bottom left reference sample (BL).

Further, the encoder/decoder may generate the right reference sample by linearly interpolating the bottom right reference sample (BR) and a reference sample (top right (TR)) adjacent to the upper right side of the current block. In other words, the encoder/decoder may generate the bottom reference samples by performing weighted-sum in units of pixel according to a distance ratio for each of the bottom right reference sample (BR) and the top right reference sample (TR).

As described above, in the linear interpolation prediction method, the encoder/decoder generates the prediction block by the weighted-addition based on the distance between a reference sample of an already encoded/decoded and reconstructed region and a predicted (i.e., generated through prediction) of a region which is not yet encoded/decoded at a current encoding time point. The linear interpolation prediction method may be used mixedly with the conventional intra prediction method and used by replacing the conventional intra prediction method.

In the present disclosure, intra prediction other than the linear interpolation intra prediction may be referred to as general intra prediction (or general intra screen prediction). For example, the general intra prediction as an intra prediction method used in the existing image compression technology (e.g., HEVC) may be an intra prediction method using one reference sample (or reference sample interpolated using two adjacent integer pixel reference samples) determined according to a prediction direction.

When the general intra prediction method and the linear interpolation prediction method are used mixedly with each other, flag information for distinguishing respective methods may be used. In this case, a problem that encoding bits increase due to flag signaling may occur. Meanwhile, when only the linear interpolation prediction method is used instead of the general intra prediction method, if the linear interpolation prediction method is lower in accuracy of the prediction than the general intra prediction method, a problem that encoding efficiency deteriorates may occur.

Accordingly, in the present disclosure, in order to solve such a problem, a new intra prediction method is proposed in which the general intra prediction method and the linear interpolation prediction method are combined. The proposed new intra prediction method may be used instead of the general intra prediction method in intra encoding/decoding and used mixedly with the general intra prediction method.

According to an embodiment of the present disclosure, the general intra prediction method and the linear interpolation prediction method are combined to solve the problem that the encoding efficiency deteriorates when the linear interpolation prediction method is lower in accuracy of the prediction than the general intra prediction method.

Further, according to an embodiment of the present disclosure, when the proposed new intra prediction method is used instead of the general intra prediction method, the flag information is not signaled, and as a result, a problem that the encoding bits increase due to use of the flag may be solved.

### Embodiment 1

An embodiment of the present disclosure proposes a new intra prediction method in which the general intra prediction method and the linear interpolation intra prediction method are combined. Hereinafter, the method will be described with reference to following drawings.

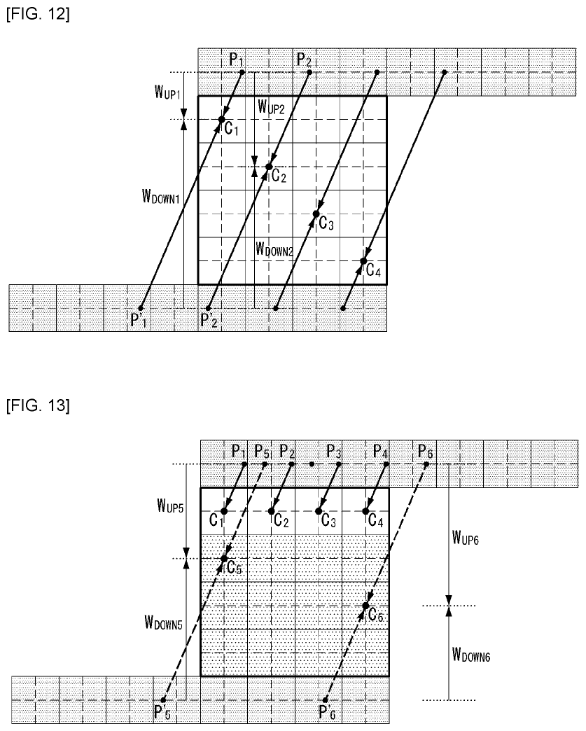

FIGS. 11 and 12 are diagrams for describing a comparison of a conventional intra prediction method and a linear interpolation intra prediction method as an embodiment to which the present disclosure may be applied.

In FIGS. 11 and 12, it is assumed that the prediction direction of the prediction mode of the current block is a positive vertical directivity illustrated in FIGS. 11 and 12.

Referring to FIG. 11, when the general intra prediction method is applied, the encoder/decoder may generate the prediction sample by copying the sample value from the top reference sample determined according to the intra prediction mode. For example, the encoder/decoder may generate the prediction sample of a C1 sample by copying a top reference sample P1. In the same method as above, the encoder/decoder may generate the prediction samples of all samples in the current block.

Referring to FIG. 12, when the linear interpolation prediction method is applied, the encoder/decoder may generate the prediction sample by interpolating (linearly interpolating) the sample values of the top reference sample and the bottom reference sample determined according to the intra prediction mode. For example, the encoder/decoder may generate the prediction sample of the C1 sample by linearly interpolating the top reference sample P1 and a bottom reference sample P′1. In this case, weights w_{UP1} and w_{DOWN1} are assigned to the P1 reference sample and the P′1 reference sample, respectively to perform linear interpolation (or weighted-addition). In the same method as above, the encoder/decoder may generate the prediction samples of all samples in the current block.

The weight determining method (w_{UP1}, w_{DOWN1}, etc.) illustrated in FIG. 12 is one example and the decoder may use the vertical distance between the current sample and the prediction sample (or reference sample) and use the actual distance between the current sample and the prediction sample (or reference sample) as illustrated in FIG. 12 in determining weights applied to the first prediction sample (P1, P2, etc.) and the second prediction sample (P′1, P′2, etc.), respectively. If the actual distance is used, the distance may be calculated and the weight may be determined (or derived) based on an actual location of the second reference sample used for generating the second prediction sample.

In the new intra prediction method in which the general intra prediction method and the linear interpolation prediction method are combined, which is proposed in the present disclosure, the general intra prediction method of FIG. 11 and the linear interpolation prediction method of FIG. 12 may be combined and applied. Hereinafter, the method will be described with reference to following drawings.

FIG. 13 is a diagram for describing a new intra prediction method according to an embodiment of the present disclosure.

Referring to FIG. 13, it is assumed that the prediction direction of the prediction mode of the current block is the positive vertical directivity illustrated in FIG. 13.

In an embodiment of the present disclosure, the encoder/decoder may divide the current block into sub-regions and apply different intra prediction methods to the divided sub-regions. Specifically, the encoder/decoder divides the current block into two sub-regions, and applies the general intra prediction method to a first sub-region to generate the prediction sample and applies the linear interpolation prediction method to a second sub-region to generate the prediction sample.

In the example of FIG. 13, since the top reference samples are used for prediction among the reference samples of the reconstructed region according to the prediction direction, the encoder/decoder may divide the current block into the first sub-region so as to include samples most adjacent to the top reference sample in the current block and divide the current block into the second sub-region so as to include the remaining samples. When the left reference samples are used for prediction among the reference samples of the reconstructed region according to the prediction direction, the encoder/decoder may configure the first sub-region so as to include samples most adjacent to the left reference sample in the current block and configure the second sub-region so as to include the remaining samples.

A first row (i.e., a top row including C1, C2, C3, and C4 samples) of the current block may be constituted by the first sub-region. The encoder/decoder may generate the prediction samples of the samples in the first sub-region (or first region) using the general intra prediction. In other words, the prediction sample of the C1 sample may be generate by copying a value of the P1 reference sample, the prediction sample of the C2 sample may be generated by copying the value of the P2 reference sample, the prediction sample of the C3 sample may be generate by copying a value of the P3 reference sample, and the prediction sample of the C4 sample may be generated by copying the value of the P4 reference sample.

In addition, second to fourth rows (i.e., remaining regions other than the first sub-region) of the current block may be constituted by the second sub-region (second region). In this case, the encoder/decoder may generate the prediction samples of the samples in the second sub-region using the linear interpolation prediction method. In other words, the prediction sample of the C5 sample of the second row may be generated through linear interpolation of applying weights of w_{DOWN5} and w_{UP5} to a top reference sample P5 value and a bottom reference sample P′5 value, respectively. The prediction sample of the C6 sample of the third row may be generated through linear interpolation of applying weights of w_{DOWN6} and w_{UP6} to a top reference sample P6 value and a bottom reference sample P′6 value, respectively. In the same method as above, the encoder/decoder may generate the prediction samples of samples in the second sub-region.

As described above, in the new intra prediction method proposed in the present disclosure, in a specific region, the prediction value is generated using the conventional intra prediction method and in the remaining regions, the prediction value is generated using the linear interpolation prediction method to generate the final prediction block.

For convenience of description, when a case where the prediction direction of the intra prediction mode is a vertical directivity (i.e., prediction directivity in which the top reference sample is used for the prediction in the reconstructed region) is assumed and described, since the top reference sample is generally a sample value reconstructed through encoding/decoding, the top reference sample is higher in accuracy than the bottom reference sample. Therefore, generating the prediction sample by copying the top reference sample value as it is by applying the general intra prediction method as the sample is closer to the top reference sample is more efficient than applying the linear interpolation prediction.

On the contrary, since the accuracy of the prediction depending on application of the general intra prediction method deteriorates as the sample is distant from the top reference sample, prediction efficiency may be increased by performing the linear interpolation using the top reference sample and the bottom reference sample.

In the method proposed in the present disclosure, the general intra prediction method and the linear interpolation prediction method may be selectively used based on a distance from the reconstructed reference sample in performing the intra prediction. In other words, the encoder/decoder may variably select which prediction method to generate the prediction block by applying among the general intra prediction method and the linear interpolation prediction method in the prediction block according to the distance from the reconstructed reference sample. In the example of FIG. 13, a 4×4 block is assumed and described, but the method may be similarly applied even to blocks (e.g., an 8×8 block, a 16×8 block, a square block, a non-square block, etc.) having various sizes or shapes.

In an embodiment, the encoder/decoder may divide the current block into the first sub-region to which the general intra prediction is applied and the second sub-region to which the linear interpolation prediction is applied based on the distance between the prediction sample (or current sample) and the reference sample of the reconstructed region. As an example, the encoder/decoder may divide the current block into the first sub-region and the second sub-region by comparing the distance between the prediction sample and the reference sample of the reconstructed region with a specific threshold. For example, the encoder/decoder may calculate the distance between the prediction sample and the reference sample of the reconstructed region, configure a sample line (or row or column) in which the calculated distance is smaller than a specific threshold by the first sub-region, and configure the remaining sample lines by the second sub-region.

Further, in an embodiment, the encoder/decoder may pre-configure a size (or the number of sample lines, the number of rows, the number of columns, etc.) of the first sub-region according to the size of the current block. For example, the encoder/decoder may constitute one sample line (or row or column) adjacent to the reconstructed reference sample (i.e., left or top reference sample) determined according to the prediction mode by the first sub-region when the current block has a size smaller than a predetermined size. In addition, the encoder/decoder may constitute two sample lines (or rows or columns) adjacent to the reconstructed reference sample (i.e., left or top reference sample) determined according to the prediction mode by the first sub-region when the current block has a size equal to or larger than a predetermined size. As an example, a table in which the number of sample lines included in the first sub-region is determined according to the size of the current block may be stored in the encoder/decoder and the current block may be divided into the first sub-region and the second sub-region by using the table.

Further, in an embodiment, the encoder/decoder may divide the current block into the first sub-region to which the general intra prediction is applied and the second sub-region to which the linear interpolation prediction is applied according to the prediction mode of the current block. As an example, a table in which the number of sample lines included in the first sub-region is determined according to the prediction mode may be stored in the encoder/decoder and the current block may be divided into the first sub-region and the second sub-region by using the table. In this case, a table including range or size information of the first sub-region corresponding to the prediction mode may be derived based on the distance between the prediction sample (or current sample) and the reference sample of the reconstructed region. In addition, the distance from the reference sample of the reconstructed region may be calculated using the prediction direction or angle of the prediction mode.

Further, in an embodiment, the encoder/decoder may divide the current block into the first sub-region to which the general intra prediction is applied and the second sub-region to which the linear interpolation prediction is applied according to the size and the prediction mode of the current block. As an example, a table in which the number of sample lines included in the first sub-region is determined according to the size and the prediction mode of the current block may be stored in the encoder/decoder and the current block may be divided into the first sub-region and the second sub-region by using the table. In this case, a table including range or size information of the first sub-region corresponding to the prediction mode may be derived based on the distance between the prediction sample (or current sample) and the reference sample of the reconstructed region and the distance from the reference sample of the reconstructed region may be calculated using the prediction direction or angle of the prediction mode.

Further, in an embodiment, the new prediction method of combining the general intra prediction method and the linear interpolation prediction method may be used by replacing all conventional directional prediction modes. In this case, the intra prediction mode may be constituted by non-directional modes (e.g., planar mode and DC mode) and proposed new prediction directional modes.

### Embodiment 2

An embodiment of the present disclosure proposes a new intra prediction method that derives the intra prediction sample by combining the general intra prediction method and the linear interpolation intra prediction method.

In an embodiment of the present disclosure, the encoder/decoder may generate the final prediction sample using the prediction sample generated through the conventional intra prediction method and the prediction sample generated through the linear interpolation prediction method.

In an embodiment, the encoder/decoder may generate the final prediction sample by performing a weighted-addition of a prediction sample (hereinafter, referred to as a third prediction sample) generated through the general intra prediction method and a prediction sample (hereinafter, referred to as a fourth prediction sample) generated through the linear interpolation prediction method. The proposed new intra prediction method may be generalized as shown in Equation 1 below.

P(i,j)=α×C(i,j)+(1−α)×L(i,j)(0≤α≤1) tm [Equation 1]

Referring to Equation 1, C(i, j) represents the intra prediction sample generated by applying the general intra prediction method described in FIG. 11 above and L(i, j) represents the intra prediction sample generated by applying the linear interpolation prediction method described in FIG. 12 above. In addition, (i, j) represent horizontal and vertical locations (or coordinates) of the corresponding prediction sample in the current block (or prediction block), respectively. As an example, a weight α may be configured as a value between 0 and 1. The encoder/decoder may generate the final prediction sample by adding the third prediction sample to which the weight α is applied and the fourth prediction sample to which a weight (1−α) is applied.

Equation 1 described above may be expressed like Equation 2 below in order to remove calculation of a floating point.

P(i,j)={A×C(i,j)+B×L(i,j)+offset}>>right shift [Equation 2]

Referring to Equation 2, A and B may represent weights applied to the third and fourth prediction samples, respectively and both A and B may be expressed as non-negative integers. As an example, an offset value may be set to 2^{(right_shift-1)}. A shift operator a>>b represents a portion obtained by dividing a by a value of 2^{b}. In Equation 2, a condition of A+B=2^{(right_shift)} may be satisfied. An integer operation may be supported through Equation 2, and as a result, computational complexity may be reduced.

### Embodiment 3

An embodiment of the present disclosure proposes various embodiments to which the generalized new intra prediction method proposed in Embodiments 1 and 2 described above is applied.

In an embodiment, a weight value of Equation 1 or 2 described above may be predefined according to the intra prediction mode. Based on Equation 1, for example, in the case of the planar mode which is the non-directional mode, the weight α value applied to the general intra prediction sample may be configured to ‘0’. In this case, the new intra prediction method may be just replaced with the linear interpolation prediction method. Further, for example, in the case of the DC mode which is the non-directional mode, the weight α value applied to the general intra prediction sample may be configured to ‘1’. In this case, the new intra prediction method may be replaced with the general intra prediction method. Further, in the case of the directional modes, the weight α value predefined according to the prediction mode may be used for intra prediction.

Further, in an embodiment, the weight value defined in Equation 1 or 2 described above may be predefined according to the location of the prediction sample in the current processing block. Based on Equation 1, for example, in the case of the prediction sample adjacent to the top reference sample and the left reference sample which are the reference samples of the reconstructed region, the weight α value applied to the prediction sample generated by the general intra prediction method may be configured to be relatively larger than other prediction samples. Here, a case where the weight α value is large may mean assigning a larger weight to the general intra prediction. As an example, as shown in Equation 3 below, the weight α may be modeled to be configured differently according to the location of the current sample in the current block (or prediction block).

P(i,j)=α(i,j)×C(i,j)+(1−α(i,j))×L(i,j)(0≤α(i,j)≤1) [Equation 3]

Here, C(i, j) represents the intra prediction sample generated by applying the general intra prediction method described in FIG. 11 above, i.e., the third prediction sample and L(i, j) represents the intra prediction sample generated by applying the linear interpolation prediction method described in FIG. 12 above, i.e., the fourth prediction sample. In addition, (i, j) represent horizontal and vertical locations (or coordinates) of the corresponding prediction sample in the current block (or prediction block), respectively. The weight α as the weight applied to the third prediction sample may be configured to a value between 0 and 1. In addition, the weight (1−α) represents the weight applied to the fourth prediction sample.

Further, in an embodiment, the weight value of Equation 1 or 2 described above may be predefined according to the size or shape of the prediction block. Based on Equation 1, for example, the encoder/decoder may configure a weight α value when the size (width×height) of the current block is smaller than a predetermined threshold which is relatively smaller than when the size is not smaller than the predetermined threshold.

Further, in an embodiment, when the weight value applied to the general intra prediction sample is ‘0’ or ‘1’, the encoder/decoder may select and use the general intra prediction method and the proposed new prediction method (or linear interpolation intra prediction method) based on additional flag information. For example, in the case of the planar mode which is the non-directional mode, the α value is configured to ‘0’ and the additional flag information is not required, but in the case of the horizontal mode, when the α value is not ‘0’ or ‘1’ (e.g., when the α value is configured to 0.5), the encoder/decoder may perform the intra prediction by selecting the prediction method applied to the current processing block among the general intra prediction method and the proposed new prediction method (or linear interpolation prediction method) based on the flag information additionally transmitted through the bitstream.

In this case, a condition in which signaling of the flag information is required may be preconfigured based on the weight value and/or the intra prediction mode. For example, the encoder/decoder may group the prediction mode into several classes as below in order to determine whether to signal the proposed additional flag information.

Class A={0, 1, 66}

Class B={2, 3, 4, . . . , 64, 65}

Class A represents a set of prediction modes not requiring the additional flag information and Class B represent a set of prediction modes requiring the additional flag information. In the above description, the prediction mode included in each class is just one example, of course.

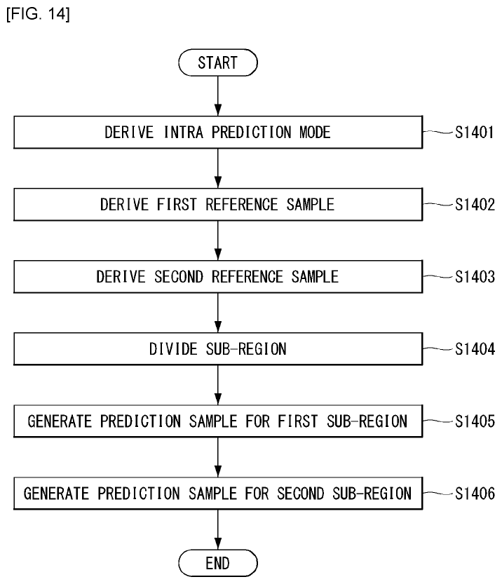

FIG. 14 is a diagram illustrating an inter prediction method according to an embodiment of the present disclosure.

Referring to FIG. 14, the method is described based on the decoder for convenience of description, but the intra prediction method proposed by the present disclosure may be equally applied even to the encoder.

First, the decoder derives the intra prediction mode of the current block (S1401).

The decoder derives a first reference sample (or reference sample array) from at least one reference sample of left, top, top left, bottom left, and top right reference samples of the current block based on the intra prediction mode (S1402).

The decoder derives a second reference sample from at least one reference sample of right, bottom, and bottom right reference samples of the current block based on the intra prediction mode (S1403). In this case, the decoder may generate the bottom right reference sample adjacent to the bottom right side of the current block as described in FIGS. 7 and 9 above and generate the right reference sample or bottom reference sample using the bottom right reference sample as described in FIGS. 7 and 10.

The decoder divides the current block into a first sub-region and a second sub-region (S1404). As described in FIG. 13 above, the decoder may divide the current block into sub-regions and apply different intra prediction methods to the divided sub-regions. Specifically, the decoder may divide the current block into two sub-regions, and applies the general intra prediction method to the first sub-region to generate the prediction sample and applies the linear interpolation prediction method to the second sub-region to generate the prediction sample.

As described above, in an embodiment, the first sub-region may include one sample line (or sample array) adjacent to the reference sample (i.e., first reference sample) determined according to the prediction direction of the intra prediction mode among the reference samples (i.e., left, top, top left, bottom left, and top right reference samples) of the reconstructed region around the current block.

Further, as described above, the decoder may variably select which prediction method to generate the prediction block by applying among the general intra prediction method and the linear interpolation prediction method in the prediction block according to the distance from the reconstructed reference sample. In other words, the first sub-region may include a specific number of sample lines adjacent to the reference sample determined according to the prediction direction of the intra prediction mode among the left, top, top left, bottom left, and top right reference samples of the current block.

As described above, the specific number may be determined based on at least one of a distance between a current sample and the first reference sample in the current block, a size of the current block, or the intra prediction mode.

The decoder generates a prediction sample for the first sub-region using the first reference sample (S1405). In other words, the decoder may generate the prediction sample by applying the general intra prediction method described in FIGS. 5, 6, and 11 above to the samples of the first sub-region.

The decoder generates the prediction sample for the second sub-region using the first and second reference samples (S1406). In other words, the decoder may generate the prediction sample by applying the linear interpolation prediction method described in FIGS. 7 to 10 and 12 above to the samples of the second sub-region.

As described above, the decoder may generate the first prediction sample using the first reference sample and generate the second prediction sample using the second reference sample. In addition, the decoder weighted-adds (or interpolates or linearly interpolates) the first prediction sample and the second prediction sample to generate the final prediction sample of the second sub-region. In this case, weights applied to the first prediction sample and the second prediction sample, respectively may be determined based on ratios between the distance between the current sample and the first reference sample and a distance between the current sample and the second reference sample in the current block.

Further, as described in Embodiments 2 and 3 above, the decoder may generate the final prediction sample by weighted-adding the prediction sample generated through the general intra prediction method and the prediction sample generated through the linear interpolation prediction method.

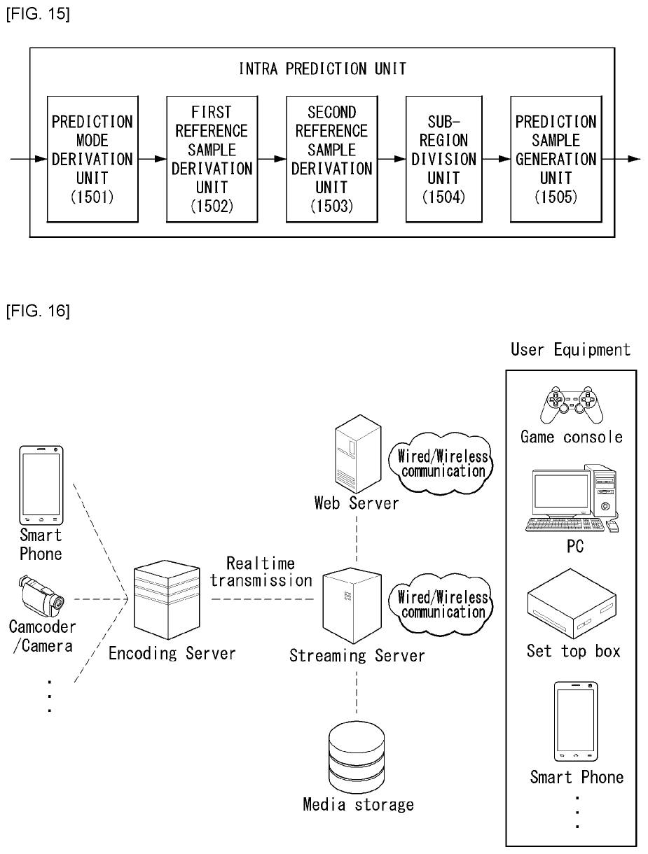

FIG. 15 is a diagram more specifically illustrating an intra prediction unit according to an embodiment of the present disclosure.

In FIG. 15, the intra prediction unit is illustrated as one block for convenience of description, but the inter prediction unit may be implemented in a configuration included in the encoder and/or the decoder.

Referring to FIG. 15, the intra prediction unit implements the functions, procedures, and/or methods proposed in FIGS. 7 to 14 above. Specifically, the intra prediction unit may be configured to include a prediction mode derivation unit 1501, a first reference sample derivation unit 1502, a second reference sample derivation unit 1503, a sub-region division unit 1504, and a prediction block generation unit 1505.

First, the prediction mode derivation unit 1501 derives the intra prediction mode of the current block.

The first reference sample derivation unit 1502 derives a first reference sample (or reference sample array) from at least one reference sample of left, top, top left, bottom left, and top right reference samples of the current block based on the intra prediction mode.

The second reference sample derivation unit 1503 derives a second reference sample from at least one reference sample of right, bottom, and bottom right reference samples of the current block based on the intra prediction mode. In this case, the second reference sample derivation unit 1503 may generate the bottom right reference sample adjacent to the bottom right side of the current block as described in FIGS. 7 and 9 above and generate the right reference sample or bottom reference sample using the bottom right reference sample as described in FIGS. 7 and 10 above.

The sub-region division unit 1504 divides the current block into the first sub-region and the second sub-region. As described in FIG. 13 above, the sub-region division unit 1504 may divide the current block into sub-regions and apply different intra prediction methods to the divided sub-regions. Specifically, the sub-region division unit 1504 may divide the current block into two sub-regions, and applies the general intra prediction method to the first sub-region to generate the prediction sample and applies the linear interpolation prediction method to the second sub-region to generate the prediction sample.

As described above, in an embodiment, the first sub-region may include one sample line (or sample array) adjacent to the reference sample (i.e., first reference sample) determined according to the prediction direction of the intra prediction mode among the reference samples (i.e., left, top, top left, bottom left, and top right reference samples) of the reconstructed region around the current block.

Further, as described above, the decoder may variably select which prediction method to generate the prediction block by applying among the general intra prediction method and the linear interpolation prediction method in the prediction block according to the distance from the reconstructed reference sample. In other words, the first sub-region may include a specific number of sample lines adjacent to the reference sample determined according to the prediction direction of the intra prediction mode among the left, top, top left, bottom left, and top right reference samples of the current block.

As described above, the specific number may be determined based on at least one of a distance between a current sample and the first reference sample in the current block, a size of the current block, or the intra prediction mode.

The prediction block generation unit 1505 generates a prediction sample for the first sub-region using the first reference sample. In other words, the prediction block generation unit 1505 may generate the prediction sample by applying the general intra prediction method described in FIGS. 5, 6, and 11 above to the samples of the first sub-region.

The prediction block generation unit 1505 generates a prediction sample for the second sub-region using the first and second reference samples. In other words, the decoder may generate the prediction sample by applying the linear interpolation prediction method described in FIGS. 7 to 10 and 12 above to the samples of the second sub-region.

As described above, the decoder may generate the first prediction sample using the first reference sample and generate the second prediction sample using the second reference sample. In addition, the decoder weighted-adds (or interpolates or linearly interpolates) the first prediction sample and the second prediction sample to generate the final prediction sample of the second sub-region. In this case, weights applied to the first prediction sample and the second prediction sample, respectively may be determined based on ratios between the distance between the current sample and the first reference sample and a distance between the current sample and the second reference sample in the current block.

FIG. 16 is a structural diagram of a content streaming system as an embodiment to which the present disclosure is applied.

Referring to FIG. 16, the content streaming system to which the present disclosure is applied may largely include an encoding server, a streaming server, a web server, a media storage, a user device, and a multimedia input device.

The encoding server compresses contents input from multimedia input devices including a smartphone, a camera, a camcorder, etc., into digital data to serve to generate the bitstream and transmit the bitstream to the streaming server. As another example, when the multimedia input devices including the smartphone, the camera, the camcorder, etc., directly generate the bitstream, the encoding server may be omitted.

The bitstream may be generated by the encoding method or the bitstream generating method to which the present disclosure is applied and the streaming server may temporarily store the bitstream in the process of transmitting or receiving the bitstream.

The streaming server transmits multimedia data to the user device based on a user request through a web server, and the web server serves as an intermediary for informing a user of what service there is. When the user requests a desired service to the web server, the web server transfers the requested service to the streaming server and the streaming server transmits the multimedia data to the user. In this case, the content streaming system may include a separate control server and in this case, the control server serves to control a command/response between respective devices in the content streaming system.

The streaming server may receive contents from the media storage and/or the encoding server. For example, when the streaming server receives the contents from the encoding server, the streaming server may receive the contents in real time. In this case, the streaming server may store the bitstream for a predetermined time in order to provide a smooth streaming service.

Examples of the user device may include a cellular phone, a smart phone, a laptop computer, a digital broadcasting terminal, a personal digital assistants (PDA), a portable multimedia player (PMP), a navigation, a slate PC, a tablet PC, an ultrabook, a wearable device such as a smartwatch, a smart glass, or a head mounted display (HMD), etc., and the like.

Each server in the content streaming system may be operated as a distributed server and in this case, data received by each server may be distributed and processed.

As described above, the embodiments described in the present disclosure may be implemented and performed on a processor, a microprocessor, a controller, or a chip. For example, functional units illustrated in each drawing may be implemented and performed on a computer, the processor, the microprocessor, the controller, or the chip.

In addition, the decoder and the encoder to which the present disclosure may be included in a multimedia broadcasting transmitting and receiving device, a mobile communication terminal, a home cinema video device, a digital cinema video device, a surveillance camera, a video chat device, a real time communication device such as video communication, a mobile streaming device, storage media, a camcorder, a video on demand (VoD) service providing device, an (Over the top) OTT video device, an Internet streaming service providing devices, a 3 dimensional (3D) video device, a video telephone video device, a transportation means terminal (e.g., a vehicle terminal, an airplane terminal, a ship terminal, etc.), and a medical video device, etc., and may be used to process a video signal or a data signal. For example, the Over the top (OTT) video device may include a game console, a Blu-ray player, an Internet access TV, a home theater system, a smartphone, a tablet PC, a digital video recorder (DVR), and the like.

In addition, a processing method to which the present disclosure is applied may be produced in the form of a program executed by the computer, and may be stored in a computer-readable recording medium. Multimedia data having a data structure according to the present disclosure may also be stored in the computer-readable recording medium. The computer-readable recording medium includes all types of storage devices and distribution storage devices storing computer-readable data. The computer-readable recording medium may include, for example, a Blu-ray disc (BD), a universal serial bus (USB), a ROM, a PROM, an EPROM, an EEPROM, a RAM, a CD-ROM, a magnetic tape, a floppy disk, and an optical data storage device. Further, the computer-readable recording medium includes media implemented in the form of a carrier wave (e.g., transmission over the Internet). Further, the bitstream generated by the encoding method may be stored in the computer-readable recording medium or transmitted through a wired/wireless communication network.

In addition, the embodiment of the present disclosure may be implemented as a computer program product by a program code, which may be performed on the computer by the embodiment of the present disclosure. The program code may be stored on a computer-readable carrier.

In the embodiments described above, the components and the features of the present disclosure are combined in a predetermined form. Each component or feature should be considered as an option unless otherwise expressly stated. Each component or feature may be implemented not to be associated with other components or features. Further, the embodiment of the present disclosure may be configured by associating some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

### INDUSTRIAL APPLICABILITY

Hereinabove, the preferred embodiments of the present disclosure are disclosed for an illustrative purpose and hereinafter, modifications, changes, substitutions, or additions of various other embodiments will be made within the technical spirit and the technical scope of the present disclosure disclosed in the appended claims by those skilled in the art.

1. A method for processing an image based on an intra prediction mode, the method comprising:
deriving an intra prediction mode of a current block;
deriving a first reference sample from at least one reference sample of left, top, top left, bottom left, and top right reference samples of the current block based on the intra prediction mode;
deriving a second reference sample from at least one reference sample of right, bottom, and bottom right reference samples of the current block based on the intra prediction mode;
dividing the current block into a first sub-region and a second sub-region;
generating a prediction sample for the first sub-region using the first reference sample; and
generating a prediction sample for the second sub-region using the first reference sample and the second reference sample.

2. The method of claim 1, wherein the first sub-region includes one sample line adjacent to a reference sample determined according to a prediction direction of the intra prediction mode among the left, top, top left, bottom left, and right reference samples of the current block.

3. The method of claim 1, wherein the first sub-region includes a specific number of sample lines adjacent to the reference sample determined according to the prediction direction of the intra prediction mode among the left, top, top left, bottom left, and top right reference samples of the current block.

4. The method of claim 3, wherein the specific number is determined based on at least one of a distance between a current sample and the first reference sample in the current block, a size of the current block, or the intra prediction mode.

5. The method of claim 1, wherein the generating of the prediction sample for the second sub-region includes
generating a first prediction sample using the first reference sample and generating a second prediction sample using the second reference sample, and
generating a final prediction sample for the second sub-region by performing a weighted-addition of the first prediction sample and the second prediction sample.

6. The method of claim 5, wherein weights applied to the first prediction sample and the second prediction sample, respectively are determined based on ratios between the distance between the current sample and the first reference sample and a distance between the current sample and the second reference sample in the current block.

7. An apparatus for processing an image based on an intra prediction mode, the apparatus comprising:
a prediction mode derivation unit deriving an intra prediction mode of a current block;
a first reference sample derivation unit deriving a first reference sample from at least one reference sample of left, top, top left, bottom left, and top right reference samples of the current block based on the intra prediction mode;
a second reference sample deriving unit deriving a second reference sample from at least one reference sample of right, bottom, and bottom right reference samples of the current block based on the intra prediction mode;
a sub-region division unit dividing the current block into a first sub-region and a second sub-region; and
a prediction sample generation unit generating a prediction sample for the first sub-region using the first reference sample and generating a prediction sample for the second sub-region using the first reference sample and the second reference sample.

8. The apparatus of claim 7, wherein the first sub-region includes one sample line adjacent to a reference sample determined according to a prediction direction of the intra prediction mode among the left, top, top left, bottom left, and right reference samples of the current block.

9. The apparatus of claim 7, wherein the first sub-region includes a specific number of sample lines adjacent to the reference sample determined according to the prediction direction of the intra prediction mode among the left, top, top left, bottom left, and top right reference samples of the current block.

10. The apparatus of claim 9, wherein the specific number is determined based on at least one of a distance between a current sample and the first reference sample in the current block, a size of the current block, or the intra prediction mode.

11. The apparatus of claim 7, wherein the prediction sample generation unit
generates a first prediction sample using the first reference sample and generates a second prediction sample using the second reference sample, and
generates a final prediction sample for the second sub-region by performing a weighted-addition of the first prediction sample and the second prediction sample.

12. The apparatus of claim 11, wherein weights applied to the first prediction sample and the second prediction sample, respectively are determined based on ratios between the distance between the current sample and the first reference sample and a distance between the current sample and the second reference sample in the current block.
